(19) United States
(12) Patent Application Publication
(10) Pub. No.: US 2009/0048906 A1
(43) Pub. Date: Feb. 19, 2009

(54) Scalable system and method for financially modeling organizational performance

(76) Inventors: John D. Carnegie, Plano, TX (US); David A. Ackley, Plano, TX (US)

Correspondence Address: John D. Carnegie, 6736 Amethyst Lane, Plano, TX, 75023, US

(21) Appl. No.: 12/221,833

(22) Filed: Aug. 7, 2008

Related U.S. Application Data
(60) Provisional application No. 60/954,420, filed on Aug. 7, 2007.

(51) Int. Cl. G06Q 10/00

(52) U.S. Cl. 705/10; 705/7

(57) ABSTRACT

A capacity based system of business-related building blocks is described that allows managers to efficiently and effectively model their current environment, to describe their organizational resources, to provide a uniform view of their workload, to communicate their organizational performance and value, and to assess the financial impact of any project.

### CROSS-REFERENCE TO RELATED APPLICATIONS

This application claims the benefit of provisional patent application Ser. No. 60/954,420 to Carnegie, et al., filed 7 Aug. 2007.

### FIELD OF THE INVENTION

This invention generally relates to systems and methods of automated financial analysis, and more particularly to modeling an organization's current and/or future financial performance.

### PROBLEM STATEMENT

Conventional accounting systems tend to be resource based. They assign a cost to a resource for a given period of time. In these systems, organizations own resources. The resource cost, organizational revenue, and organizational expenses provide a relatively comprehensive view of cost and revenue. Shortcomings include but are not limited to: not conclusively assigning costs and expenses for work performed in direct support of various consumers, not accounting for soft costs, not identifying hidden costs, and not forecasting, in a predictive manner, the financial impact of any project.

In Activity Based Costing (ABC) systems, the activities (work units) associated with one or more revenue generating business processes are identified. The resources necessary to deliver the work units are also identified. The sum of the time spent in performing all work units is considered to fully allocate the resource cost. Thus, as the volume of work units changes, the apparent cost per work unit varies. This deficiency was addressed in Time Driven-Activity Based Costing (TD-ABC) systems. Shortcomings of ABC systems include but are not limited to: they are not widely effective outside manufacturing companies, the inability to effectively account for and derive support costs, the inability to account for soft costs, and the inability to, in a predictive manner, forecast the financial impact of any project.

In TD-ABC systems, the work units associated with one or more revenue generating business processes are also identified. Resources are identified and their associated cost rates are assigned to the work units based on the activity duration. This approach establishes a volume-independent cost per activity. Shortcomings of TD-ABC systems include but are not limited to: the inability to effectively account for and derive support costs, the inability to account for soft costs, and the inability to, in a predictive manner, forecast the financial impact of any project.

ABC and TD-ABC are operational process models. They address the application of resources to revenue generation and assume the costs for making those resources available are appropriately allocated as overhead. For the most part, they rely on conventional accounting systems to tally various costs and revenues that are then allocated within the models. In both ABC and TD-ABC, there is an explicit and incorrect assumption that, for a given activity owned by a specified department/organization, then the personnel or other resources assigned to this activity are owned by the same department/organization. Resources and activities are strongly related in that an activity cannot be performed unless at least one appropriate resource is available to participate in the associated work. Neither ABC nor TD-ABC systems account for resource availability support, for the cost impact of the non-availability of a resource, or for project effort and impact.

Total cost of ownership (TCO) accrues costs associated with a set of resources. In general, the approach identifies the current value of the resources, identifies the work to support those resources, and assigns a cost to that work. The total of the current value and the support costs is the cost of ownership. This model addresses only the work that necessary to assure the availability of resources for company purposes.

### BRIEF DESCRIPTION OF THE DRAWINGS

FIG. 1 shows a service (work unit) and its relationships with its consumers, a need, expenses, revenues, an organization, and resources.

FIG. 2 shows a typical process structure with its interrelated activities (work units).

FIG. 3 shows a typical project structure with its interrelated tasks (work units).

FIG. 4 shows processes and their relationships with its consumers, needs, expenses, revenues, organizations, and resources.

FIG. 5 shows projects and their relationships with its consumers, needs, expenses, revenues, organizations, and resources.

FIG. 6 shows a project's impact on workload.

FIG. 7 shows the time allocation of resource capacity.

FIG. 8 shows the creation of a collection.

FIG. 9 shows a paste operation whereby a linear transform on a consumer's needs is performed.

FIG. 10 shows a paste operation where additional transformations are performed.

FIG. 11 shows a paste operation with several additional transformations.

FIG. 12 shows a setup of the environment for an analysis.

FIG. 13 shows the analysis relationships.

FIG. 14 shows the selection of the analysis reports.

FIG. 15 shows a scenario setup for comparing two collections.

FIG. 16 shows a sample cash flow with envelope.

### EXEMPLARY DESCRIPTION OF A PREFERRED EMBODIMENT

In business, work is divided into finite units of time whereby each unit has a beginning-to-end construct. During this beginning-to-end time, one or more resources with current cost values are assigned to produce some result. Similar results provide a classification of the work as a work unit. Intrinsically, a work unit is defined as a class whose instances deliver a useful result. Work units are delivered at least once and deliver their value to one or more consumers. Each instance delivers its value in some finite period of time. Hence, work units have frequency and duration.

A company typically applies its resources in three ways: to support revenue generation, to assure the availability of the resources necessary for revenue generation, and to implement change. A given resource may perform all three functions. In some companies, the relationship of revenue generation and resource availability is multi-layered. For example, in a manufacturing company, a piece of equipment may need a person to run diagnostics each day. In turn, the person performing the diagnostics uses a laptop with a specialized software program. On a weekly basis, that program is updated by a person in the Information Technology (IT) department with the manufacturer's latest diagnostics update.

The preferred embodiment of the invention is a computer application that uses a relational database management programs. The purpose of the program is to facilitate the gathering of work unit data from various organizational elements, to facilitate the insertion of the gathered data into a relational database such that an organization with all its hierarchy is represented, to assign and reassign portions of resources to the work units, to create arbitrary subsets of the work units including sets representing processes and projects, to vary the number of resources assigned to the subsets, to perform computational analysis on a given subset to ascertain total resource usage and cost per work unit, to aggregate the cost and revenue results, to provide methods by which a subset of work units is transformed into a new subset that represents a future state, to provide financial comparisons of one work unit subset to another, and to report the analysis, aggregation, and comparison results in a manner that provides managers a basis for actions.

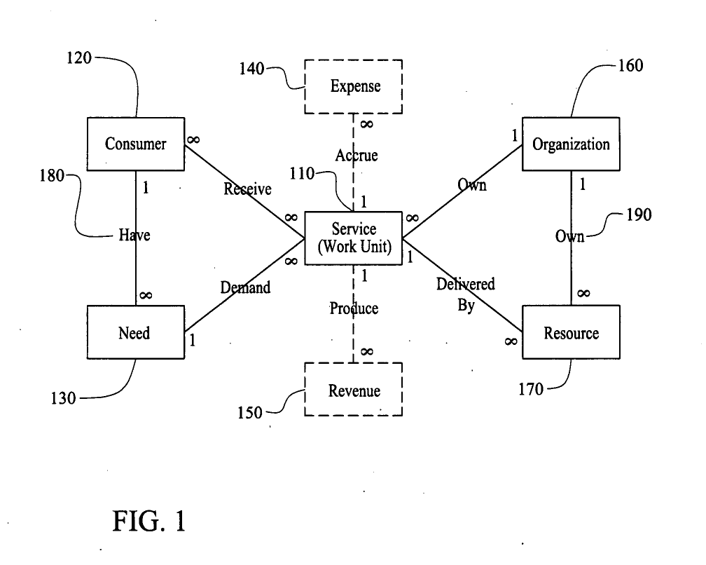

FIG. 1 shows a service (work unit) and its relationships with its consumers, consumer needs expenses, revenues, an organization, and resources. The term “work unit” 110 is used interchangeably with the following terms in the business community: task, activity, and service. The term service is interchangeable to work unit only when used to mean the delivery of work as opposed to the availability of a resource. A work unit instance is time based, e.g. it has a starting time and an ending time. The difference between the ending time and the starting time summed over all instances of the same work unit and divided by the instance count is called the work unit's average duration. A work unit has an instance count over some finite period of time, e.g. a quarter or year. The instance count divided by the period of time is called the work unit's frequency.

Only one organization 160 owns the responsibility for the result of a work unit. Consequently, the formal enumeration of the work units owned by a given organization constitutes that organization's responsibility to the company. It is also noted that each organization is assigned a subjective metric that is called its maturity. In the present embodiment, this assigned metric is mapped into the set of real numbers ranging from one to five.

A resource 170 is an object that contributes work to produce the result associated with a work unit instance. Intrinsically, a resource is used to deliver more than one work unit instance and has a total capacity for a given period of time. This capacity may or may not be fully utilized. Like resource objects are grouped together into a resource class. For example, a person is a member of the resource class, people. For another example, a five axis Omni-mill is a member of the resource class, milling machines.

Resources are owned 190 by an organization. A resource has a cost rate, although that rate may approach zero. The cost rate may change. For example, if a milling machine is depreciated over a seven year period of time, then the cost of its contribution to a work unit changes from time period to time period. The concept of workload is defined as the cumulative time delivered by an organization's resources to any organization's work units.

The delivery of a work unit instance might accrue an expense 140. For example, the repair of a computer might entail the replacement of a part. The cost of that part is an expense incidental to the work unit delivery. Over time, the expenses for a work unit can be summed and divided by the work unit instance count to arrive at an average expense per work unit. Similarly, the delivery of a work unit instance might entail the garnering of revenues 150. Hence work units might have an average revenue associated with its delivery. In the embodiment, both expense and revenue can be fixed, duration, or instance based.

A consumer 120 receives the work unit result. Consumers have 180 needs 130. These needs place demands on the work units. Formally, needs have two parts: a name, called a work aggregation class, and a count. For example, a consumer might have need of the use of twelve milling machines for its manufacturing facility. In this case, the work aggregation class is ‘milling machines’ and the count is twelve. A work unit, ‘maintain milling machines’ is performed in response to a ‘milling machine’ demand. There is a special relationship between needs (work aggregation classes and counts) and the work unit: as the count varies, the associated work units' frequencies vary proportionately (a linear relationship).

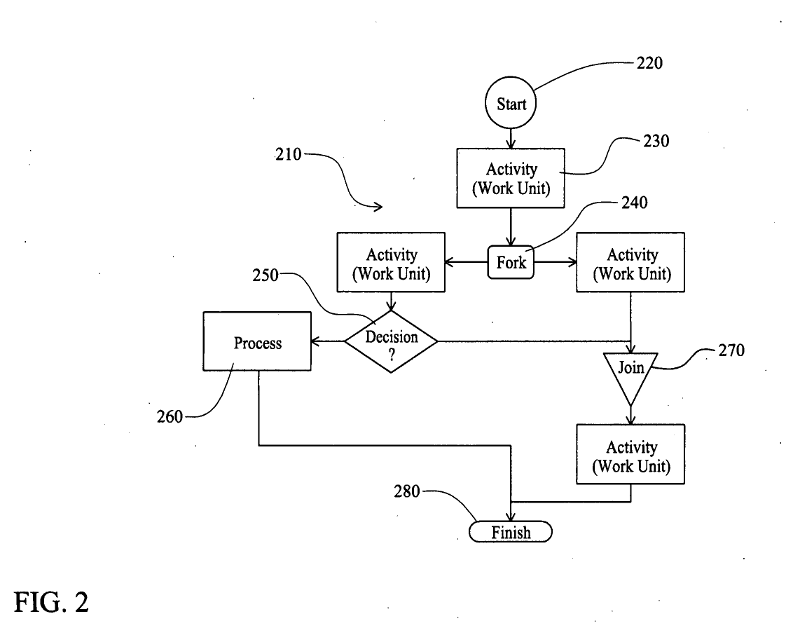

FIG. 2 shows a process structure 210 with its interrelated activities (work units) 230. Control structures and relationships, such as a Start 220, Fork 240, Decision 250, Join 270, Finish 280, and predecessor/successor associations, manage the process flow to produce its result(s). A process may include loops and hierarchy. Hierarchy is achieved by allowing a process to contain another process 260. Processes provide inter- and intra-organizational work structure and work focus for work that is repetitively performed.

When performing a financial analysis on the work units contained within a process, it is unnecessary to know and/or understand the process structure. This is because the work unit frequency provides sufficient information to perform the analysis.

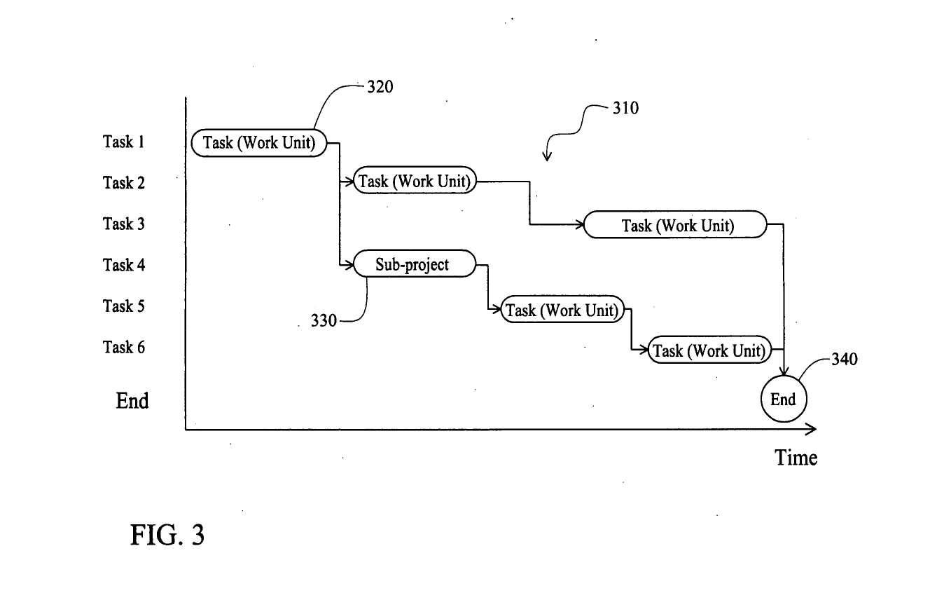

FIG. 3 shows a project structure 310 with its interrelated tasks (work units) 320. Flow of control and relationships are accomplished with structures similar to those of processes, including an End 340 node. Hierarchy is accomplished with sub-projects 330. There are two types of projects: inward facing and outward facing. Inward facing projects change the nature of one or more organization's workload. Outward facing projects perform work that delivers results to an external organization.

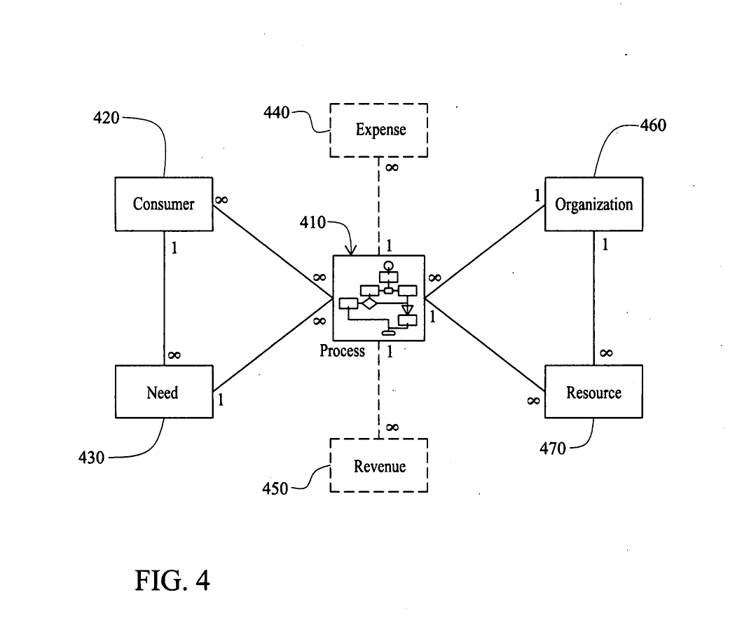

FIG. 4 shows processes 410 and their relationships with consumers, needs, expenses, revenues, organizations, and resources. Hence, processes have the same relationships as work units. The responsibility for a process is owned by organization 460. The work of a process is performed by one or more resources 470 each or which is owned by an organization. Like work units, processes can accrue expenses 440 or garner revenue 450. The results of a process are delivered to a consumer 420 in response to that consumer's needs 430. A process has its own frequency and duration. The work units internal to the process are proportional to the process's frequency. Consequently, a process can be represented as an abstracted view of its work units.

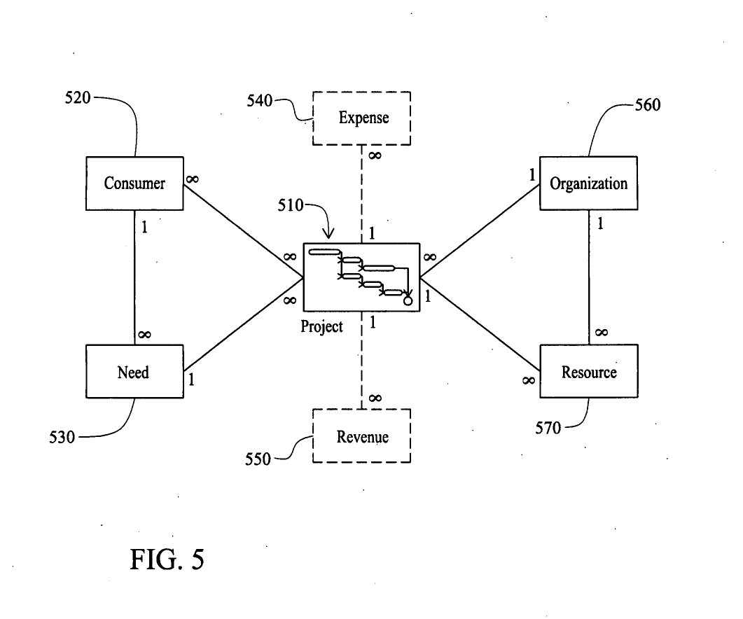

FIG. 5 shows projects 510 and their relationships with its consumers, needs, expenses, revenues, organizations, and resources. Hence, projects have the same relationships as work units. The responsibility for a project is owned by organization 560. The work of a project is performed by one or more resources 570 each or which is owned by an organization. Like work units, projects can accrue expenses 540 or garner revenue 550. The results of a project are delivered to a consumer 520 in response to that consumer's needs 530. A project has its own frequency (normally, although not always, the project instance count is one) and duration. The work units internal to the project are proportional to the project's frequency. Consequently, a project can be represented as an abstracted view of its work units.

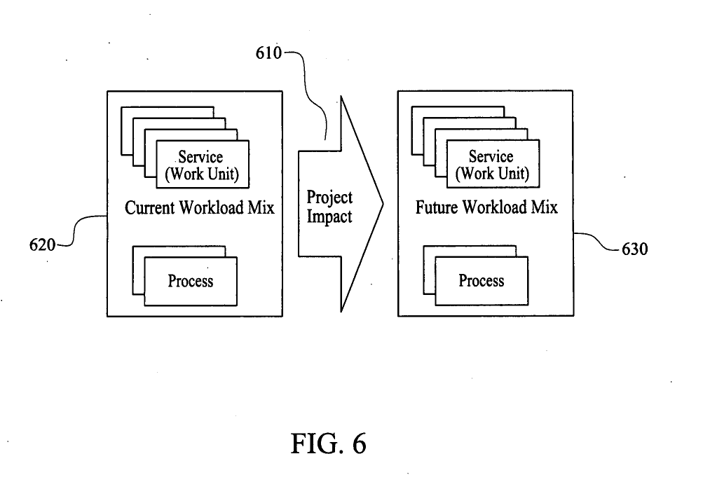

FIG. 6 shows a project's impact on workload. Company inward facing projects change the nature of processes and standalone services (work units) and, therefore, may impact costs and revenues. An inward facing project's impact 610 is to transform subsets of work units and processes representing the current workload 620 into a new set of work units and processes that represent a future workload state 630. Company outward facing projects deliver some value to a consumer and, when completed, may result in a change in the operating state the delivering organization (e.g. a change in revenue, resources, etc).

The preferred embodiment of the invention accommodates gathering work unit data with and without prior knowledge of the targeted business or business support area. When gathering the data, the focus is on the organization.

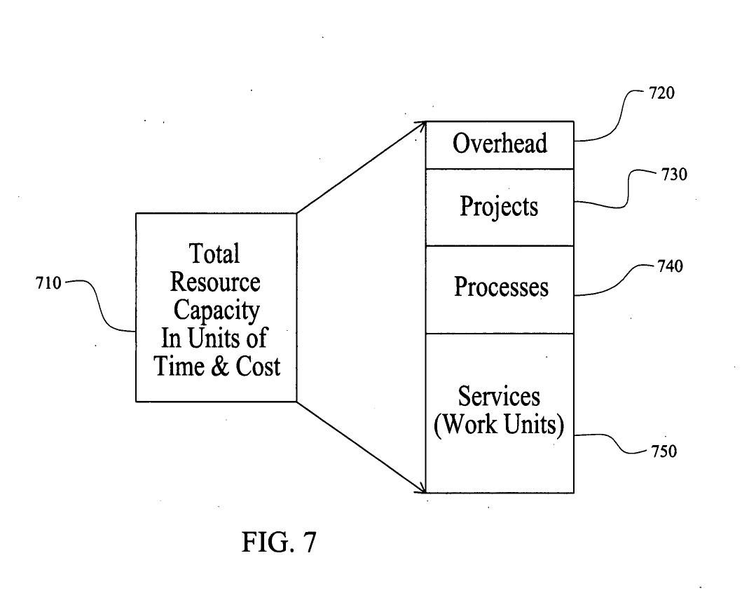

FIG. 7 shows the time allocation of resource capacity. The total available time capacity and total average cost of resources 710 are identified. The available resource time is divided into four parts: overhead 720, project 730, process 740 and services (work units) 750. Overhead time is captured as time periods for which the resource accrues cost but does not contribute useful work. For example, an employee might receive ten work days each year as paid holidays. This employee entitlement reduces the time when the resource (person) is available to perform useful work but still accrues cost. Project time is captured by identifying the project tasks (work units) for which a given organization is responsible and by noting the duration and applied resources. Similarly, process time is captured by formally naming each process, by identifying the process activities (work units) for which a given organization is responsible, by noting the frequency and duration of each activity, and by noting the resources applied to each activity. Finally, the services (work units) are formally named and their frequency, duration, and resource usage are captured. This data is then inserted into the relational database in a manner that conforms to the relationships defined in FIG. 1.

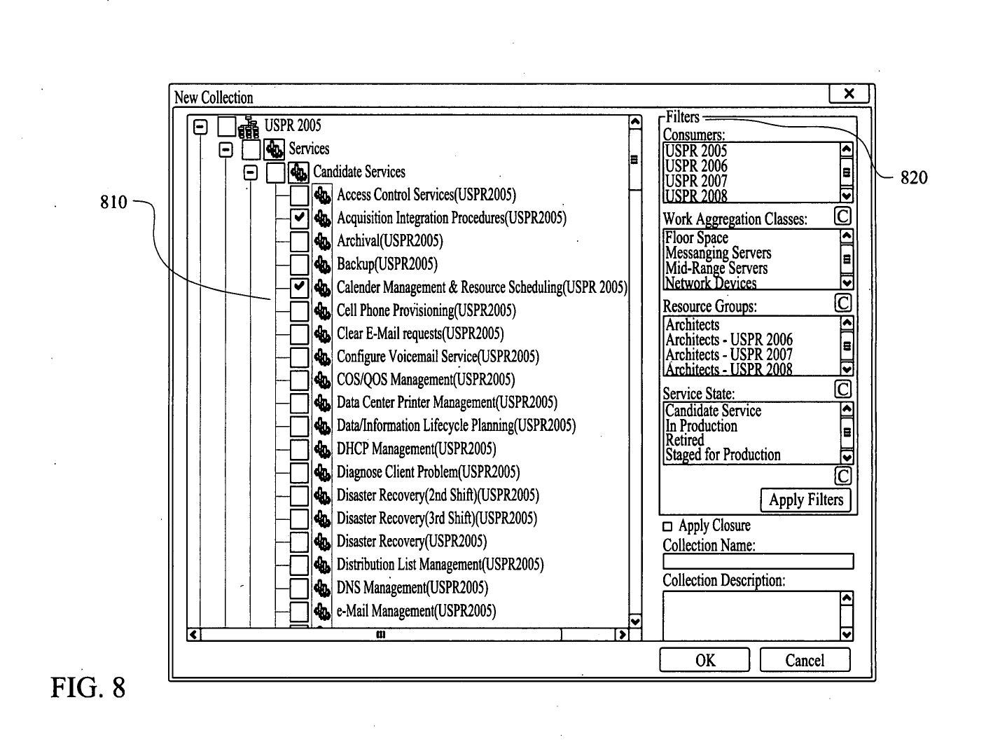

FIG. 8 shows the creation of a collection. The embodiment provides capabilities for creating arbitrary subsets of work units (e.g., selecting individual work units 810) called collections. One of the collections might include all of the work units. This capability lets one examine areas of interest without necessarily having to analyze all the work units. The embodiment's user interface facilitates filtering 820 of the work units based on the relationships shown in FIG. 1 at the collection creation time.

The present embodiment provides procedures to copy work units associated with collections and organizations and then paste these work units into an existing organization or into a proposed new organization. The paste operation can target the source database or different database.

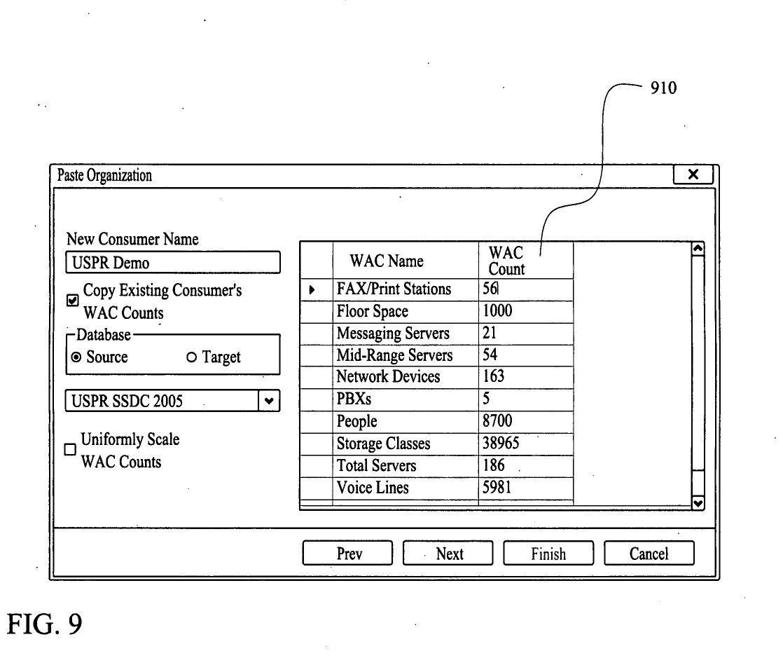

FIG. 9 shows a paste operation whereby a linear transform on a consumer's needs is performed. The user interface provides the capability to modify a consumer's work aggregation class counts 910.

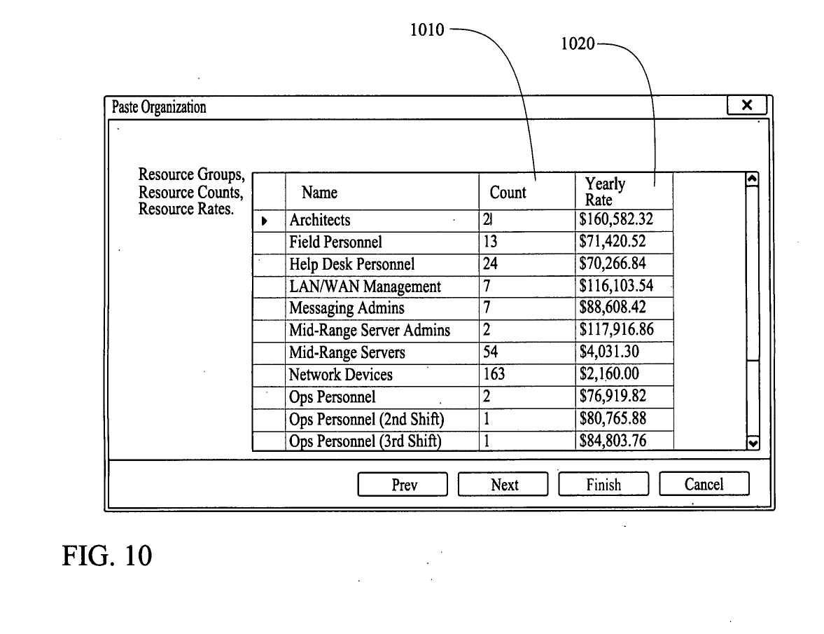

FIG. 10 shows a paste operation where additional transformations are performed. In this case, transforms are shown for resource count 1010 and resource cost rate 1020.

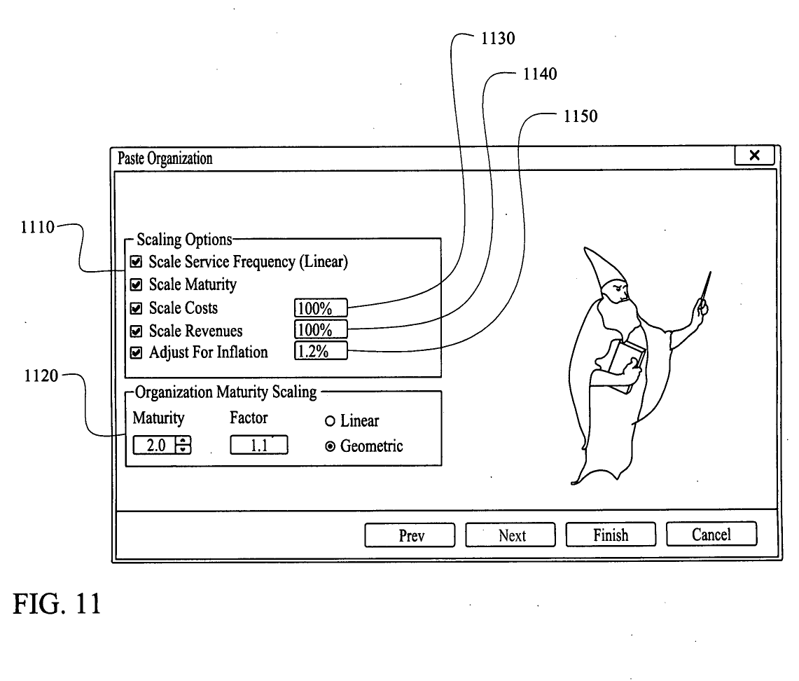

FIG. 11 shows a paste operation with several additional transformations. The transforms include but are not limited to: frequency 1110 (whereby the new work unit's frequency is the product of the old frequency and the ratio of the target work aggregation class count to the source work aggregation class count), organizational maturity 1120, the work unit's associated costs 1130, the work unit's associated revenues 1140, and the adjustment of resource cost rate due to inflation 1150.

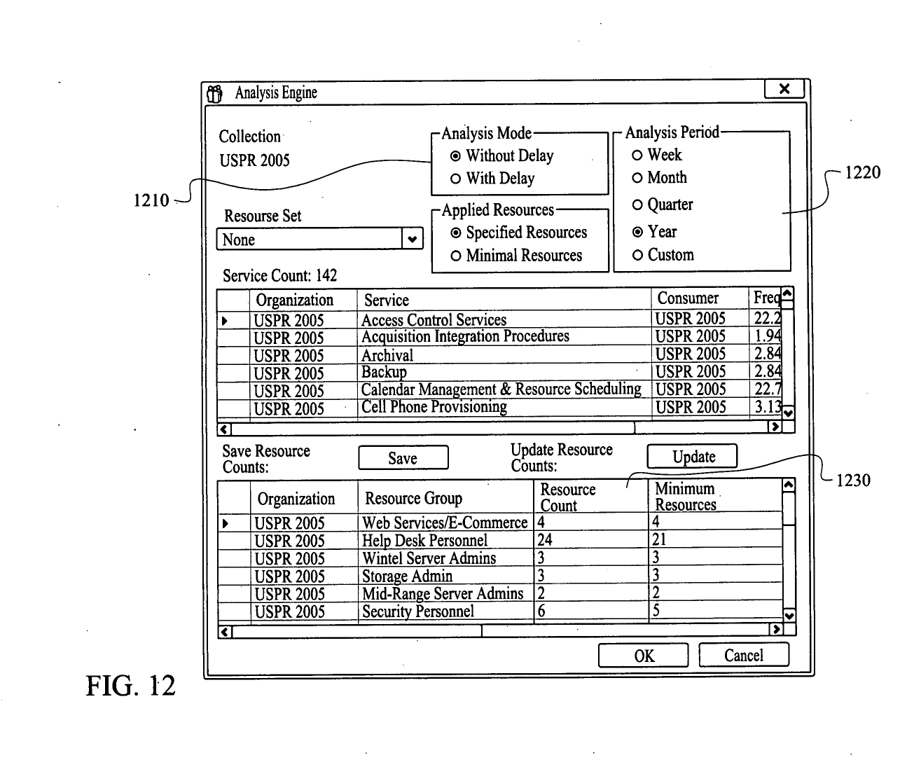

FIG. 12 shows a setup of the environment for an analysis. The invention includes a mechanism to analyze the work units in a collection and store the results. The user interface establishes the starting conditions for the analysis, including but not limited to: the analysis type 1210 of with or without delay, analysis's period of time 1220, and the number of resources 1230 to be used. Other embodiments might also include a time line that represents seasonality to be applied during the analysis period.

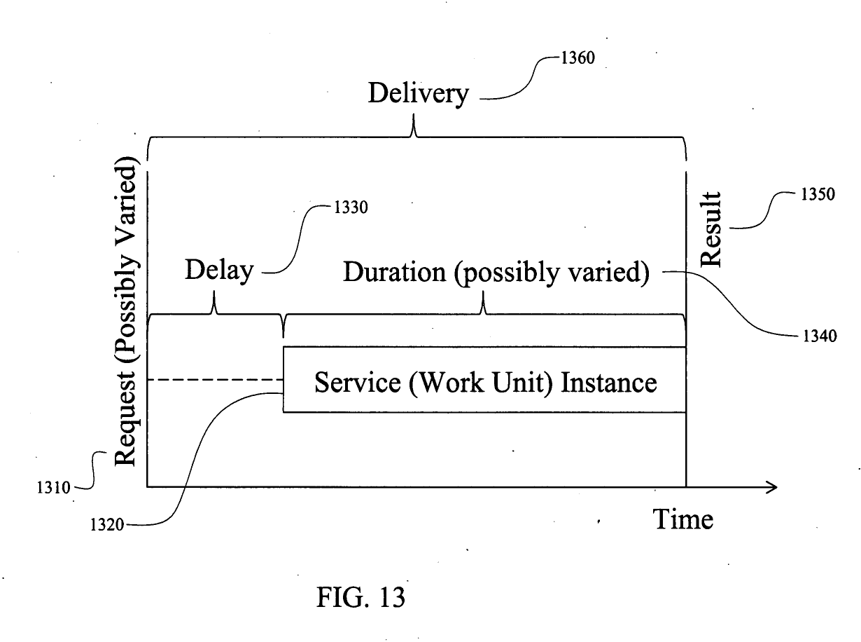

FIG. 13 shows the analysis relationships. There are two types of analyses: averaged (without delay) and stochastic (with delay). For an averaged analysis, the time between work unit requests 1310 is constant and based strictly on the work unit frequency. A work unit instance's start time 1320 is always the same as the request time, e.g. the delay time 1330 is zero, and therefore the work unit delivery time 1360 and duration 1340 are equal and therefore, the time to deliver the work unit's result 1350 is constant. For an averaged analysis, the work unit's duration is the same for all instances. Hence, the total request count for the analysis period and average work unit duration are used as multipliers to calculate the cumulative resource usage time and total resource cost. In the averaged case, resources are always assumed to be available.

The stochastic analysis uses a discrete simulation approach that varies each work unit instance's request 1310 time and duration 1340. Like resources are pooled and, as a work unit instance request is posted, a determination is made as to the availability of the necessary resource(s). If the resource(s) are available, they are assigned to the work unit instance and the instance start 1320 occurs. Simultaneously, the count(s) associated with the pool(s) of resources are decremented. When the work unit instance has completed, e.g. posted its result 1350, a computation is performed to calculate the work unit instance's delay, the cumulative resource usage time and resource total cost. These values are accumulated over the entire analysis period. Furthermore, the resource pool count(s) are incremented. If other work unit instances require a resource from a pool whose count is zero, a delay 1330 of that work unit instance occurs until such time as the resources become available.

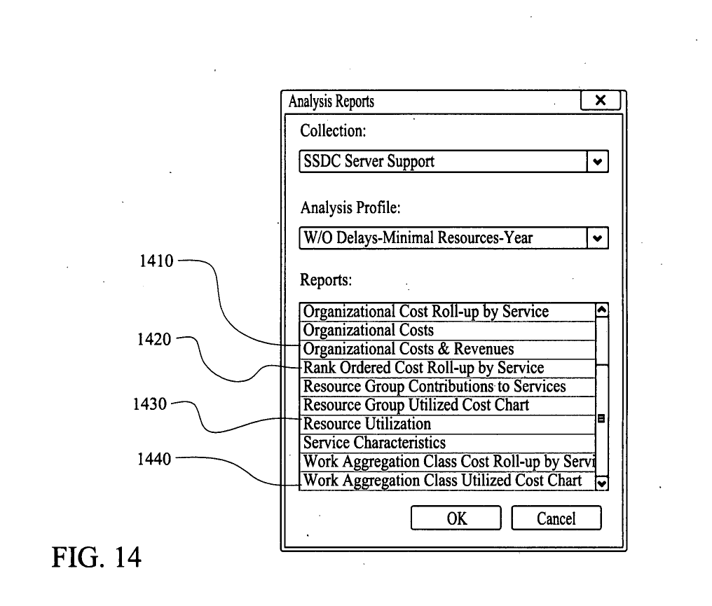

FIG. 14 shows the selection of the analysis reports. These reports include mechanisms to aggregate the collection analysis results and present these results in ways that are meaningful to managers. Some of the interesting reports include but are not limited to: organizational costs and revenues 1410, rank ordered cost roll-up by service 1420, resource utilization 1430, and work aggregation class utilized cost chart 1440.

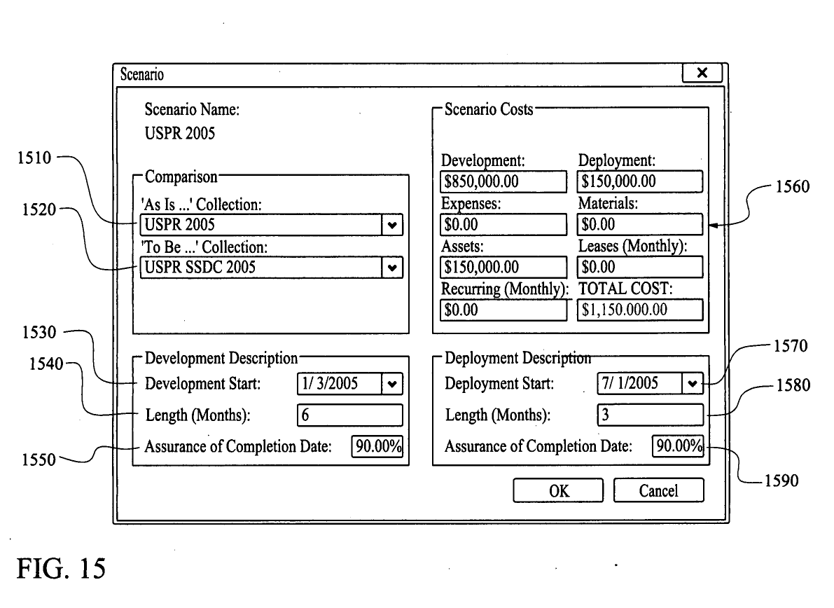

FIG. 15 shows a scenario setup for comparing two collections. In the preferred embodiment, an inward looking project performs work that transforms one or more organizations from one operational state to another. These two states are represented by two collections bound by the project and called a scenario. The ‘As Is . . . ’ collection 1510 is compared to the ‘To Be . . . ’ collection 1520. The transition from ‘As Is . . . ’ to ‘To Be . . . ’ is represented in two phases: development and deployment. The development has a start date 1530, a length 1540, and the project manager's confidence 1550 in the development completion date. Deployment moves the development results into an operational state. Similar to development, deployment has a start date 1570, a length 1580, and the project manager's confidence 1590 in the deployment completion date. The project manager's confidence in achieving the completion dates is used to create the cash flow envelope. The development and deployment times may overlap or be disjoint. The project costs 1560 are the costs necessary to move from the ‘As Is . . . ’ state to the ‘To Be . . . ’ state. The embodiment treats each scenario as an investment and provides financial metrics feedback, such as return on investment (ROI), internal rate of return (IRR), and project break even month (BEM).

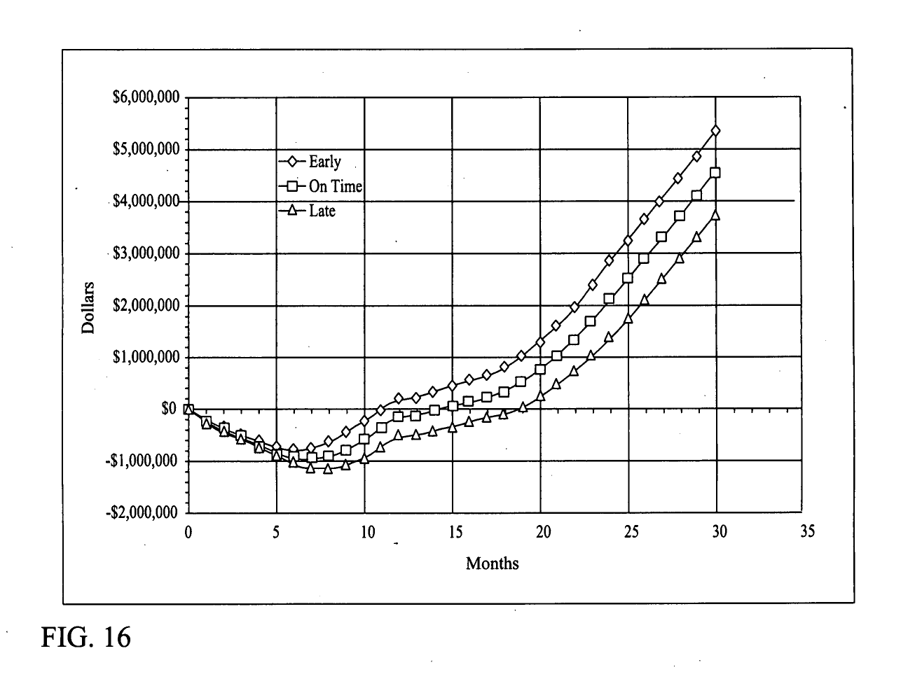

FIG. 16 shows a sample cash flow with envelope. This envelope provides a unique visualization of the financial impact when the project is completed early, on time, or late.

The foregoing merely illustrates the principles of the invention. It will thus be appreciated that those skilled in the art will be able to devise numerous other arrangements that embody the principles of the invention and are thus within the spirit and scope of the invention, which is defined by the claims, below.

What is claimed is:

1. A time capacity based financial modeling system, the system comprising:
a structured database comprising building blocks and business relationships;
a data gathering subsystem that organizes and compiles the inputs and appropriately formats those inputs based on the relationships in the structured database;
a collections subsystem that creates subsets of the work units;
a copy and paste subsystem that copies the work units of a collection or an organization and pastes the work units into a new organization;
an analysis subsystem that calculates a work unit's resource usage, cumulative instance count, cumulative duration, and delay statistical data over a specified period of time;
a costs and revenues subsystem that computes work unit resource costs, expenses and revenues;
a business relationships subsystem that financially aggregates work unit counts, resource usages, costs, and revenues.
a.

2. The system of claim 1 further comprising a reports subsystem that creates financial reports and charts of the analysis results of a collection.

3. The system of claim 1 further comprising a scenario subsystem that associates two collections, a project name, and the project development and deployment schedules and costs;

4. The system of claim 1, the structured database subsystem with building blocks comprising:
work units comprising name, frequency, frequency statistics, duration, duration statistics;
organizations comprising structure and maturity;
resources comprising availability, capacity, count, cost rate;
consumers;
needs comprising name (henceforward referred to work aggregation class) and count;
expenses;
revenues;
processes;
projects.

5. The system of claim 1, the structured database subsystem with business relationships comprising:
a many-to-one relationship of work units to an organization;
a one-to-many relationship of a work unit to resources;
a one-to-many relationship of a work unit to expenses;
a one-to-many relationship of a work unit to revenues;
a many-to-many relationship of work units to consumers;
a one-to-many relationship of a work unit to work aggregation classes;
a many-to-one relationship of work units to a process;
a many-to-one relationship of work units to a project;
a one-to-many relationship of a consumer to work aggregation classes;
a one-to-many relationship of an organization to resources;

6. The system of claim 1, the data gathering subsystem further comprising:
an input subsystem to characterize the usage of resources in terms of overhead, projects, processes, and work units;
a reformatting subsystem to translate the inputted data into a form conforming to the structured database.

7. The system of claim 1, the copy and paste subsystem comprising:
a create new, empty structured database subsystem;
a copy work units subsystem from an organization or a collection in an existing structured database;
a paste work units subsystem into an existing or new organization in the same structured database or a different structured database. The paste work units subsystem preserves the organizational structure if the copy work units subsystem source is an organization or else, if the source is a collection, then the paste destination must be an existing organization.

8. The subsystem of claim 7, the paste work units subsystem includes, but is not limited to, the following transforms:
scaling work unit frequencies and associated resource counts based on changes in consumer work aggregation class counts;
scaling work unit durations based on changes in delivery organization maturity level;
scaling resource costs based on annual inflation;
scaling expenses;
scaling revenues.

9. The system of claim 2, the reports subsystem includes, but not limited to, the following reports and charts:
full time equivalent personnel by work aggregation class report;
actual cost by organization chart;
utilized cost by organization chart;
organizational cost rollup by work unit report;
cost by organization summary report;
actual costs and revenues by organization report;
ranked order cost rollup by work unit report;
resource group contribution to work units report;
resource group utilized cost chart;
resource utilization report;
work unit statistical characteristics report;
work aggregation class cost rollup by work unit report;
work aggregation class utilized cost chart;
scenario cash flow chart;
scenario investment metrics report.
